(19) United States
(12) Patent Application Publication
(10) Pub. No.: US 2026/0203929 A1
(43) Pub. Date: Jul. 16, 2026

(54) LEARNING APPARATUS, ESTIMATION APPARATUS, LEARNING METHOD, ESTIMATION METHOD, AND NON-TRANSITORY COMPUTER-READABLE MEDIUM

(71) Applicant: NEC Corporation, Tokyo (JP)

(72) Inventor: Hiroo IKEDA, Tokyo (JP)

(73) Assignee: NEC Corporation, Tokyo (JP)

(21) Appl. No.: 19/136,415

(22) PCT Filed: Dec. 7, 2023
(86) PCT No.: PCT/JP2023/043824

§ 371 Date: Jun. 6, 2025

(30) Foreign Application Priority Data
Dec. 15, 2022 (JP) 2022-200103

(51) Int. Cl. G06T 7/70

(52) U.S. Cl. CPC G06T 7/70; G06T 2207/20081; G06T 2207/20084

(57) ABSTRACT

The present invention provides a learning apparatus including an acquisition unit that acquires learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another, and a learning unit that learns, based on the learning data, an estimation model of estimating information indicating a likelihood of a central position, on the image, of each human body, a relative position, on the image, of each key point associated with each human body, and a relative position, in the depth direction, of each key point associated with each human body.

### TECHNICAL FIELD

The present invention relates to a learning apparatus, an estimation apparatus, a learning method, an estimation method, and a program.

### BACKGROUND ART

A technique related to the present invention is disclosed in Non-Patent Document 1. The technique in Non-Patent Document 1 is used in order to estimate position information (three-dimensional skeletal information) in a real space at a key point of a human body (a joint point/skeletal point of the human body) from an image by use of a learned estimation model.

The conventional technique in Non-Patent Document 1 estimates a position coordinate in a real space (three dimensions) at a key point of a human body (a joint point/skeletal point of the human body) by inputting a single image into a learned estimation model configured by a convolutional neural network. Data pairing an image with the position coordinate in a real space at the key point of the human body are used for learning data.

### Related Document

### Patent Document

Non-Patent Document 1: Bugra Tekin et al., Structured Prediction of 3D Human Pose with Deep Neural Networks, [Searched on Sep. 20, 2022], Internet, <URL:https://arxiv.org/abs/1605.05180>

### DISCLOSURE OF THE INVENTION

### Technical Problem

A problem of Non-Patent Document 1 is that, in learning of an estimation model, it is difficult to collect learning data such as a position coordinate in a real space (three-dimensional skeletal information) at a key point of a human body, and the estimation model cannot be easily learned.

A reason for this is that, for a position coordinate in a real space (three dimensions) at a key point of a human body, learning data cannot be readily generated/collected manually with only a human body image, unlike a position coordinate on an image (two dimensions), and learning data cannot be collected without using large-scale equipment such as a motion capture system.

A further problem is that, in learning data of an image paired with a position coordinate in a real space (three dimensions), learning data with many variations cannot be collected.

A reason for this is that equipment such as a motion capture system is installed in a limited environment such as an indoor laboratory due to an installation condition of the equipment, and an image to be captured is limited in variation such as a background, the number of persons, a depth, and the like.

A further problem is that, in a case where an amount or a variation of learning data is insufficient, estimation accuracy of an estimation model, i.e., accuracy of processing of estimating, from an image, position information, in a real space, at a key point of a human body becomes low.

One example of an object of the present invention is to provide a learning apparatus, an estimation apparatus, a learning method, an estimation method, and a program that solve any one of challenges described above.

### Solution to Problem

According to one example aspect of the present invention, there is provided a learning apparatus including:
an acquisition unit that acquires learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another; and
a learning unit that learns, based on the learning data, an estimation model of estimating information indicating a likelihood of a central position, on the image, of each human body, a relative position, on the image, of each key point associated with each human body, and a relative position, in the depth direction, of each key point associated with each human body.

According to one example aspect of the present invention, there is provided an estimation apparatus including
an estimation unit that estimates, by use of an estimation model learned by the learning apparatus, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.

According to one example aspect of the present invention, there is provided a learning method including,
by one or more computers:
   acquiring learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another; and
   learning, based on the learning data, an estimation model of estimating information indicating a likelihood of a central position, on the image, of each human body, a relative position, on the image, of each key point associated with each human body, and a relative position, in the depth direction, of each key point associated with each human body.

According to one example aspect of the present invention, there is provided a program causing a computer to function as:
an acquisition unit that acquires learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another; and
a learning unit that learns, based on the learning data, an estimation model of estimating information indicating a likelihood of a central position, on the image, of each human body, a relative position, on the image, of each key point associated with each human body, and a relative position, in the depth direction, of each key point associated with each human body.

According to one example aspect of the present invention, there is provided an estimation method including,
by one or more computers,
   estimating, by use of an estimation model learned by the learning apparatus, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.

According to one example aspect of the present invention, there is provided a program causing a computer to function as
an estimation unit that estimates, by use of an estimation model learned by the learning apparatus, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.

### Advantageous Effects of Invention

One example aspect of the present invention solves a challenge of providing a learning apparatus, a learning method, and a program that can easily learn/construct an estimation model learned with a sufficient amount and variation of learning data in an apparatus that estimates, by use of a learned estimation model, position information, in a real space, at a key point of a human body from an image.

Moreover, one aspect of the present invention solves a challenge of providing an estimation apparatus, an estimation method, and a program that estimate position information, in a real space, at a key point of a human body from an image with high accuracy.

### BRIEF DESCRIPTION OF THE DRAWINGS

The above-described object, other objects, features, and advantageous effects will become more apparent from a public example embodiment described below and the following accompanying drawings.

FIG. 1 It is a diagram for describing a technique according to the present example embodiment.

FIG. 2 It is a diagram for describing the technique according to the present example embodiment.

FIG. 3 It is a diagram for describing the technique according to the present example embodiment.

FIG. 4 It is a diagram for describing the technique according to the present example embodiment.

FIG. 5 It is one example of a functional block diagram of a learning apparatus according to the present example embodiment.

FIG. 6 It is one example of a functional block diagram of a learning apparatus according to the present example embodiment.

FIG. 7 It is a flowchart illustrating one example of a flow of processing of the learning apparatus according to the present example embodiment.

FIG. 8 It is one example of a functional block diagram of an estimation apparatus according to the present example embodiment.

FIG. 9 It is one example of a functional block diagram of the estimation apparatus according to the present example embodiment.

FIG. 10 It is a diagram for describing processing of the estimation apparatus according to the present example embodiment.

FIG. 11 It is a diagram for describing processing of the estimation apparatus according to the present example embodiment.

FIG. 12 It is a diagram for describing the technique according to the present example embodiment.

FIG. 13 It is a flowchart illustrating one example of a flow of processing of the estimation apparatus according to the present example embodiment.

FIG. 14 It is one example of a functional block diagram of a three-dimensional skeletal estimation apparatus according to the present example embodiment.

FIG. 15 It is a diagram for describing the technique according to the present example embodiment.

FIG. 16 It is a diagram for describing the technique according to the present example embodiment.

FIG. 17 It is a diagram illustrating one example of a hardware configuration of the apparatus according to the present example embodiment.

### EXAMPLE EMBODIMENT

Hereinafter, example embodiments of the present invention are described by use of the drawings. Note that, in all of the drawings, a similar component is assigned with a similar reference sign, and description thereof is omitted as appropriate.

### First Example Embodiment

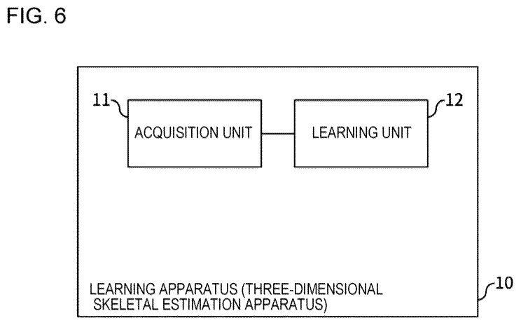

FIG. 6 is a functional block diagram illustrating an outline of a learning apparatus 10 according to the first example embodiment. The learning apparatus 10 includes an acquisition unit 11 and a learning unit 12. The acquisition unit 11 acquires learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another. The learning unit 12 learns, based on the learning data, an estimation model of estimating information indicating a likelihood of a central position, on the image, of each human body, the relative position, on the image, of each key point associated with each human body, and the relative position, in the depth direction, of each key point associated with each human body.

The learning apparatus 10 with such a configuration can easily learn/construct an estimation model learned with a sufficient amount and variation of learning data in an apparatus that estimates, by use of a learned estimation model, position information, in a real space, at a key point of a human body from an image.

### Second Example Embodiment

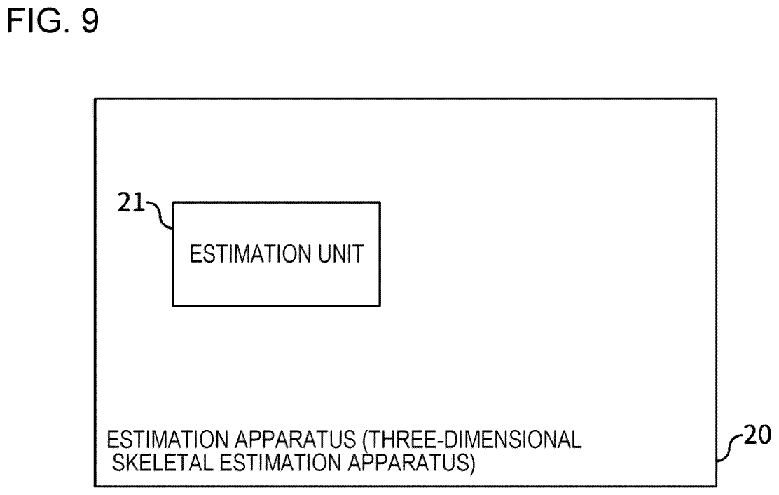

FIG. 9 is a functional block diagram illustrating an outline of an estimation apparatus 20 according to a second example embodiment. The estimation apparatus 20 includes an estimation unit 21. The estimation unit 21 estimates, by use of an estimation model learned by a learning apparatus 10 described in the first example embodiment, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.

The estimation apparatus 20 with such a configuration can estimate position information, in a real space, at a key point of a human body from an image with high accuracy.

### Third Example Embodiment

### Outline

Instead of estimating “position information, in a real space, of a key point of a human body” from an image, an estimation apparatus 20 according to the present example embodiment estimates similar information that is “position information, in a real space, of a human body” and “position information, in a real space, of a key point associated with a human body”.

“Position information, in a real space, of a human body” is a position coordinate, on an image, of the human body and order, in a depth direction in a real space, of the human body. Moreover, “position information, in a real space, of a key point associated with a human body” is a position coordinate, on an image, of a key point associated with a human body, and a relative position, in the depth direction, of a key point associated with a human body with a human body center as a criterion. A position, in a real space, of a key point in the depth direction can be determined by the relative position in the depth direction, and order, in the depth direction in a real space, of the human body being relevant to the relative position.

A learning apparatus 10 according to the present example embodiment learns a neural network (estimation model) that outputs information necessary in order to derive the information described above (information related to the information described above). The information described above, and output information of the estimation model related to the information described above can be easily collected/generated manually with only a human body image. Thus, it is possible to easily collect/generate learning data of the estimation model. Thereby, an estimation model can be easily learned/constructed in an apparatus that estimates position information, in a real space, at a key point of a human body from an image.

### Feature of Technique According to the Present Example Embodiment

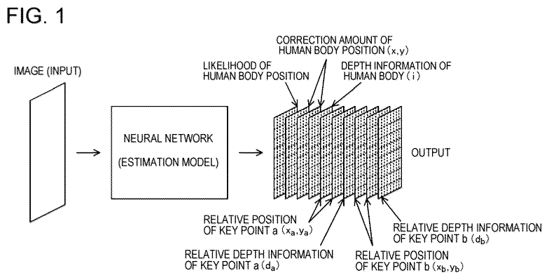

A technique according to the present example embodiment is described. As illustrated in FIG. 1, once an image is input to a neural network, a plurality of pieces of data as illustrated in the figure are output. In other words, the neural network according to the present example embodiment is configured by a plurality of layers that output a plurality of pieces of data as illustrated in the figure.

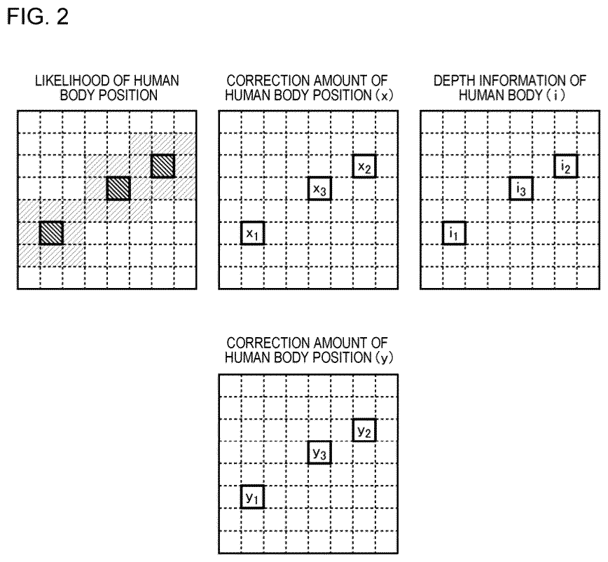

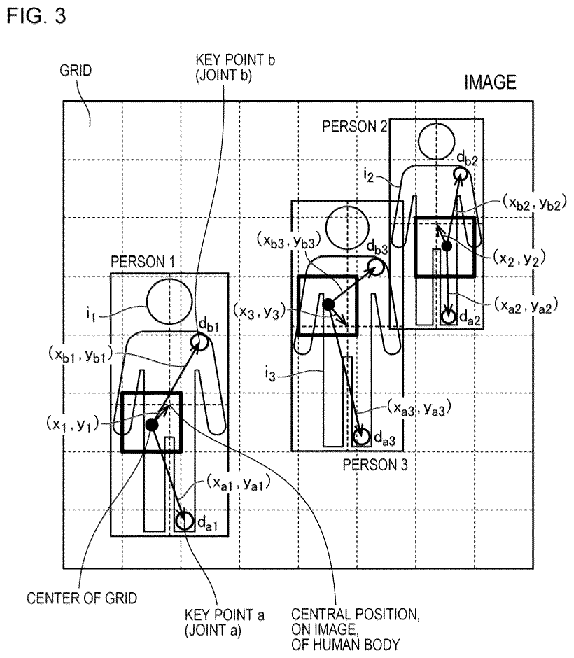

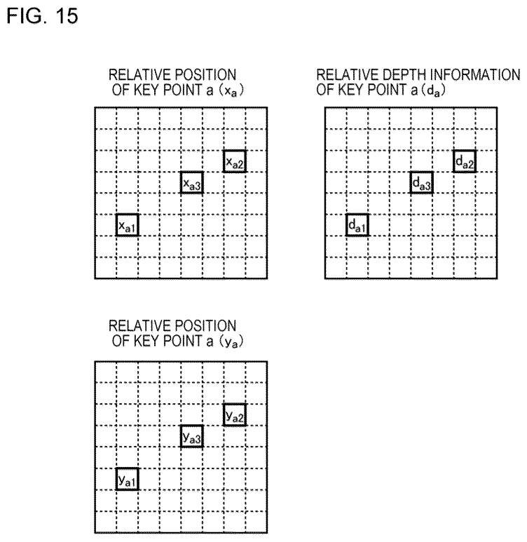

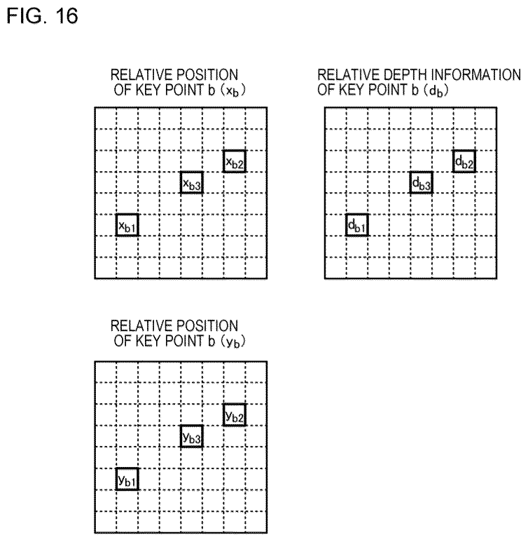

FIG. 2 illustrates one example of “a likelihood of a human body position”, “a correction amount of a human body position”, and “depth information of a human body” among a plurality of pieces of data illustrated in FIG. 1. FIG. 15 illustrates one example of “a relative position of a key point a” and “relative depth information of the key point a” among a plurality of pieces of data illustrated in FIG. 1. FIG. 16 illustrates one example of “a relative position of a key point b” and “relative depth information of the key point b” among a plurality of pieces of data illustrated in FIG. 1. FIG. 3 illustrates a diagram in which a description indicating a concept of each piece of data in FIGS. 2, 15, and 16 is added to an image being a source of the data in FIGS. 2, 15, and 16.

The data of “a likelihood of a human body position” illustrated in FIG. 2 are data indicating a likelihood of a central position of the human body (a position of the human body) on an image as illustrated in FIG. 3. As illustrated in the figure, the data indicate a likelihood that the central position, on the image, of the human body is located in each of a plurality of grids acquired by dividing the image. The likelihood may be indicated by a normal distribution or the like centered on a grid indicating the central position, on the image, of the human body. Note that, a method of dividing the image into a grid shape is a matter of design, and the number of grids and a size thereof illustrated in the figure are merely one example.

According to the data illustrated in FIG. 2, “a grid being second from left and third from bottom”, “a grid being fourth from right and fourth from top”, and “a grid being second from right and third from top” are determined as grids in which a central position, on the image, of a human body is located. In a case where an image including a plurality of human bodies is input as illustrated in FIG. 3, a grid in which a central position, on the image, of each of a plurality of human bodies is located is determined.

The data of “a correction amount of a human body position” illustrated in FIG. 2 are data indicating a movement amount in an x direction and a movement amount in a y direction of moving from a center of a grid where a central position, on the image, of the human body is determined to be located, to the central position, on the image, of the human body, as illustrated in FIG. 3. The data of “a correction amount of a human body position” are stored at a position of a grid where the central position, on the image, of the human body is determined to be located. As illustrated in FIG. 3, the central position, on the image, of the human body exists at a certain position within one grid. By utilizing a likelihood of the human body position and a correction amount of the human body position, the central position, on the image, of the human body (a position of the human body) can be determined.

The data of “depth information of a human body” illustrated in FIG. 2 are data indicating order in the depth direction in a real space for the human body in the grid where the central position, on the image, of the human body is determined to be located as illustrated in FIG. 3. The data of “depth information of a human body” are stored at a position of a grid where the central position, on the image, of the human body is determined to be located.

Moreover, the depth direction is a direction indicating a near/far side seen from a camera. Alternatively, the depth direction may be a direction of an optical axis of the camera. The order is assigned to a human body captured within an image, and is, for example, a numerical value or the like in which a person nearest to the camera within the image is given 0, and order increases one by one as movement is made farther from the camera. To describe with FIG. 3 as an example, a person 1 is located nearest to the camera in a real space, and the person 1, a person 3, and a person 2 are lined up in order from the near side toward the far side from the camera. Accordingly, the depth information of the human body is 0 (=i₁) for the person 1, 1 (=i₃) for the person 3, and 2 (=i₂) for the person 2.

Moreover, order may also be normalized to a value of 0 to 1 by dividing in such a way that order at the farthest side within the image becomes 1. Further, for order, a numerical value increasing one by one from the near side is used, but a numerical value reflecting a distance between persons in a real space (it may be an apparent distance) may be used. With the orders, a correct answer can be generated visually from a human body image, and learning data can be easily collected.

The data of “a relative position of a key point” illustrated in FIGS. 15 and 16 are data indicating a relative position, on the image, of each key point with respect to a human body in a grid where the central position, on the image, of the human body is determined to be located as illustrated in FIG. 3. Specifically, the data indicate a movement amount in the x direction and a movement amount in the y direction of moving from a center of a grid where a central position, on the image, of the human body is determined to be located, to a position, on the image, of each key point being relevant to the human body. The data of “a relative position of a key point” are stored at a position of a grid where the central position, on the image, of the human body is determined to be located. As illustrated in FIG. 3, the central position, on the image, of the human body exists at a certain position within one grid. By utilizing a likelihood of the human body position and a relative position of each key point, a position, on the image, of each key point of the human body can be determined.

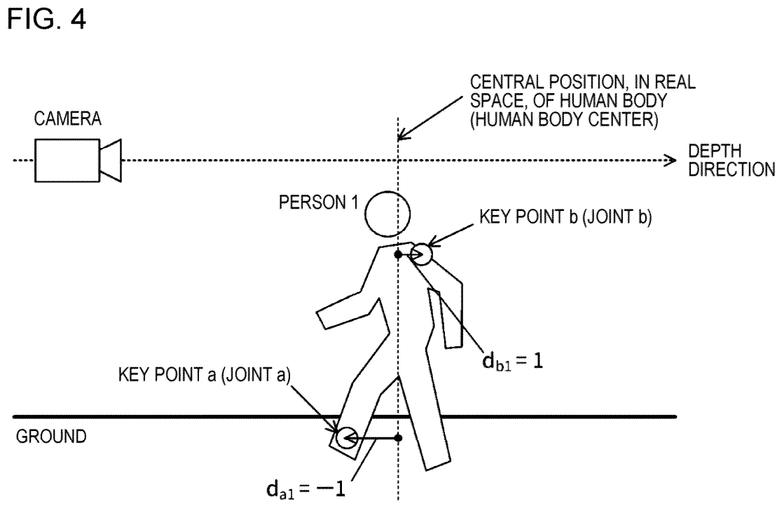

The data of “relative depth information of a key point” illustrated in FIGS. 15 and 16 are data indicating a relative position in the depth direction with a central position, in a real space, of the human body as a criterion, at each key point being relevant to the human body in a grid where the central position, on the image, of the human body is determined to be located as illustrated in FIG. 3. The data of “relative depth information of a key point” are stored at a position of a grid where the central position, on the image, of the human body is determined to be located. Moreover, the depth direction is a direction indicating a near/far side seen from a camera. Alternatively, the depth direction may be a direction of an optical axis of the camera. The relative position in the depth direction is, for example, set to a negative value in a case where a key point exists on a near side, with a central position, in a real space, of the human body as a criterion, set to a positive value in a case where a key point exists on a far side, or set to 0 in a case where a key point exists at the central position, in a real space, of the human body. To describe with FIG. 4 as an example, the key point a of the person 1 is located near to the camera, with a central position, in a real space, of the human body as a criterion. Moreover, the key point b of the person 1 is located on the far side from the camera, with a central position, in a real space, of the human body as a criterion. Accordingly, relative depth information of the key point is −1 (=dₐ₁) for the key point a of the person 1, and 1 (=d_{b1}) for the key point b of the person 1. Although a form of three values of −1, 0, and 1 is used as the relative depth information of the key point in FIG. 4, a numerical value directly reflecting a position (it may be an apparent position) from the central position, in a real space, of the human body may be used. With the relative positions in the depth direction, a correct answer can be generated visually from a human body image, and learning data can be easily collected.

Note that, in FIG. 3, positions of two key points are illustrated for each person, but the number of key points can be three or more.

The technique according to the present example embodiment outputs a plurality of pieces of data as described above from an input image, then minimizes a value of a predetermined loss function, based on the plurality of pieces of data and a previously given correct answer label, and thereby computes (learns) a parameter of an estimation model.

Moreover, during estimation, a grid where a central position, on the image, of each human body is located is determined based on the data of “a likelihood of a human body position” illustrated in FIG. 2, and a correction amount being relevant to a position of the determined grid is acquired from the “a correction amount of a human body position” illustrated in FIG. 2. Based on the position of the determined grid (a central position of the grid) and the acquired correction amount, a central position, on the image, of a human body on each human body is determined.

Next, depth information being relevant to the position of the determined grid is acquired from the data of “depth information of a human body” illustrated in FIG. 2. Order, in the depth direction in a real space, of each human body is determined by the acquired depth information. Next, a relative position of each key point being relevant to the position of the determined grid is acquired from the data “a relative position of each key point” illustrated in FIG. 2. A position, on the image, of each key point on each human body is determined based on the position of the determined grid (a central position of the grid) and the acquired relative position of each key point.

Next, relative depth information of each key point being relevant to the position of the determined grid is acquired from the data of “relative depth information of each key point” illustrated in FIGS. 15 and 16. From the acquired relative depth information of each key point, a relative position, in the depth direction, of each key point on each human body is determined with the central position, in a real space, of the human body as a criterion.

As described above, during estimation, a grid where a central position, on an image, of each human body is located is determined, and position information, in a real space, at a key point of a human body, indicated by position information, in a real space of, the human body (a central position, on the image, of a human body on each human body and order, in the depth direction in a real space, of each human body), and position information in a real space of the key point associated with the human body (a position of each key point on each human body on the image and a relative position in the depth direction with a central position, in a real space, of the human body at each key point on each human body as a criterion) is determined based a position of the determined grid.

Then, by including the feature described above, the technique according to the present example embodiment can easily learn/construct an estimation model in an apparatus that uses a learned estimation model, and estimates position information, in a real space, at a key point of a human body from an image.

### Functional Configuration

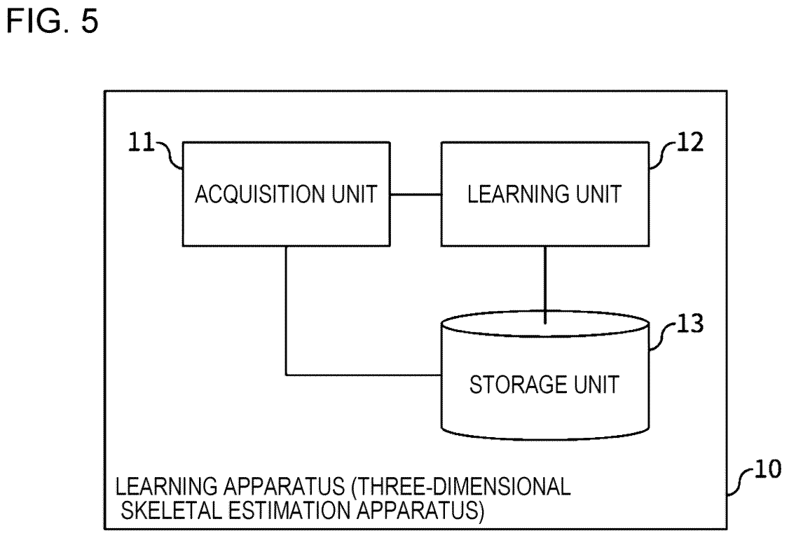

Next, a functional configuration of the learning apparatus 10 according to the present example embodiment is described. One example of a functional block diagram of the learning apparatus 10 is described in FIG. 5. As illustrated in the figure, the learning apparatus 10 includes an acquisition unit 11, a learning unit 12, and a storage unit 13. Note that, as illustrated in a functional block diagram of FIG. 6, the learning apparatus 10 may not include the storage unit 13. In this case, an external apparatus configured to be able to communicate with the learning apparatus 10 includes the storage unit 13.

The acquisition unit 11 acquires learning data in which a training image is associated with a correct answer label. The training image includes a person. The training image may include only one person, or may include a plurality of persons. The correct answer label indicates at least a position, on an image, at each key point on a human body, a relative position, in the depth direction, of each key point on the human body with a central position, in a real space, of the human body as a criterion, a central position, on the image, of the human body, and order, in the depth direction, of a human body. The central position, on the image, of the human body may be computed from a position, on an image, at each key point on a human body. For example, it may be a center of a rectangle including a position of each key point on the human body, or may be a center of gravity using a position of each key point on the human body. Moreover, a correct answer label may also be a new correct answer label acquired by fabricating the correct answer label described above. For example, it may be a correct answer label such as a plurality of pieces of data illustrated in FIG. 1 fabricated from the correct answer label described above.

For example, an operator who prepares a correct answer label may perform a task or the like of specifying a position inside an image, for “a position, on an image, of each key point on a human body” and “a central position, on an image, of a human body” that are the correct answer labels. Moreover, the operator who prepares a correct answer label may perform a task or the like of specifying a relative position and order, for “a relative position, in the depth direction, of each key point on a human body with a central position, in a real space, of the human body as a criterion” and “order, in the depth direction, of a human body” that are correct answer labels, in line with how a person appears inside an image.

Herein, a key point may be at least a part of a joint portion, a predetermined part portion (an eye, a nose, a mouth, a navel, and the like), or an extremity of a body (a tip of the head, a fingertip, a toe, and the like). Moreover, a key point may be another portion. A way of defining the number and positions of key points varies, and is not particularly limited.

For example, many pieces of learning data are stored in the storage unit 13. Then, the acquisition unit 11 can acquire learning data from the storage unit 13.

The learning unit 12 learns an estimation model, based on learning data. The storage unit 13 stores the estimation model. The estimation model is configured by a neural network described by use of FIG. 1. The estimation model outputs a plurality of pieces of data illustrated in FIG. 1. The plurality of pieces of data illustrated in FIG. 1 indicate position information, in a real space, of a human body, and information required to derive position information, in a real space, of a key point associated with the human body, and indicate a likelihood of a human body position, a correction amount of the human body position, depth information of the human body, a relative position of each key point, and relative depth information of each key point. Details relating to the plurality of pieces of data are described above.

Then, various types of estimation processing can be performed by use of the plurality of pieces of data output by the estimation model. For example, an estimation apparatus (e.g., the estimation apparatus 20 described in the following example embodiment) derives, from the estimation model, a plurality of pieces of data as described by use of FIGS. 1 to 3, 15, and 16. By use of the plurality of pieces of data acquired by the estimation model, the estimation apparatus can estimate position information, in a real space, of the human body (a central position, on an image, of a human body on each human body, and order, in the depth direction in a real space, of each human body), and position information, in a real space, of a key point associated with the human body (a position, on an image, of each key point on each human body, and a relative position, in the depth direction, of each key point on each human body with a central position, in a real space, of the human body as a criterion).

For example, the estimation apparatus determines a central position, on the image, of a human body on each human body, based on a likelihood of a human body position and a correction amount of a human body position illustrated in FIG. 2. Moreover, the estimation apparatus determines order, in the depth direction in a real space, of each human body, based on a likelihood of a human body position and depth information of the human body illustrated in FIG. 2. Moreover, the estimation apparatus determines a position, on the image, of each key point on each human body, based on a likelihood of a human body position and a relative position of each key point illustrated in FIGS. 2, 15, and 16. Moreover, the estimation apparatus determines a relative position, in the depth direction, of each key point with a central position, in a real space, of a human body as a criterion, based on a likelihood of a human body position and relative depth information of each key point illustrated in FIGS. 2, 15, and 16.

In a case of learning an estimation model, the learning unit 12 can learn (adjust) a parameter of an estimation model in such a way as to minimize an error between each of the plurality of pieces of data described above output from the estimation model being learned, and each of the plurality of pieces of data described above in learning data (a correct answer label). In addition, the learning unit 12 can learn by targeting all grids for the data of “a likelihood of a human body position”. Moreover, the learning unit 12 can learn by targeting only a grid where a central position, on an image, of a human body is located in the learning data, for the data of “a correction amount of a human body position”, “depth information of a human body”, “a relative position of each key point”, and “relative depth information of each key point”.

Herein, a specific example of a method of learning by the learning unit 12 is described.

Regarding the data “a likelihood of a human body position”, the learning unit 12 can learn (adjust) a parameter of an estimation model in such a way as to minimize an error between a map indicating a likelihood of a human body position output from an estimation model being learned, and a map indicating a likelihood of a human body position in learning data (a correct answer label) for positions of all grids.

Moreover, regarding the data of “a correction amount of a human body position”, the learning unit 12 can learn (adjust) a parameter of an estimation model in such a way as to minimize an error between an correction amount of a human body position output from an estimation model being learned, and a correction amount of a human body position in learning data (a correct answer label), for only a position of a grid where a central position, on an image, of a human body is located in learning data.

Moreover, regarding the data of “depth information of a human body”, the learning unit 12 can learn (adjust) a parameter of an estimation model in such a way as to minimize an error between depth information of a human body output from the estimation model being learned, and depth information of a human body in learning data (a correct answer label), for only a position of a grid where a central position, on an image, of a human body is located in learning data.

Moreover, regarding the data of “a relative position of each key point”, the learning unit 12 can learn (adjust) a parameter of an estimation model in such a way as to minimize each of errors between a relative position of each key point output from an estimation model being learned, and a relative position of each key point in learning data (a correct answer label) for only a position of a grid where a central position, on an image, of a human body is located in learning data.

Moreover, regarding the data of “relative depth information of each key point”, the learning unit 12 can learn (adjust) a parameter of an estimation model in such a way as to minimize each of errors between relative depth information of each key point output from an estimation model being learned and relative depth information of each key point in learning data (a correct answer label), for only a position of a grid where a central position, on an image, of a human body is located in learning data.

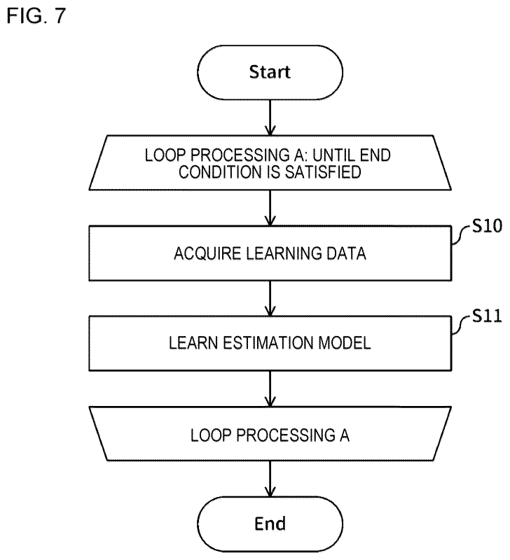

One example of a flow of processing of the learning apparatus 10 is described by use of FIG. 7.

In S10, the learning apparatus 10 acquires learning data in which a training image is associated with a correct answer label. The processing is achieved by the acquisition unit 11. Details of the processing executed by the acquisition unit 11 are as described above.

In S11, the learning apparatus 10 learns an estimation model by use of the learning data acquired in S10. The processing is achieved by the learning unit 12. Details of the processing executed by the learning unit 12 are as described above.

The learning apparatus 10 repeats a loop of S10 and S11 until an end condition is satisfied. The end condition is defined, for example, by use of a value of a loss function, or the like

### Hardware Configuration

Next, one example of a hardware configuration of the learning apparatus 10 is described. Each functional unit of the learning apparatus 10 is achieved by any combination of hardware and software mainly including a central processing unit (CPU) of any computer, a memory, a program loaded onto the memory, a storage unit such as a hard disk that stores the program (that can store not only a program previously stored from a phase of shipping an apparatus but also a program downloaded from a medium such as a compact disc (CD) or a server or the like on the Internet), and an interface for network connection. Then, it is appreciated by a person skilled in the art that there are a variety of modified examples of a method and an apparatus for the achievement.

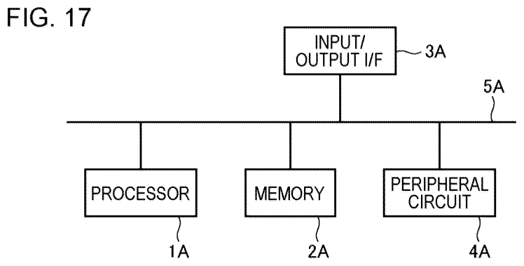

FIG. 17 is a block diagram illustrating a hardware configuration of a learning apparatus 10. As illustrated in FIG. 17, the learning apparatus 10 includes a processor 1A, a memory 2A, an input/output interface 3A, a peripheral circuit 4A, and a bus 5A. The peripheral circuit 4A includes various modules. The learning apparatus 10 may not include the peripheral circuit 4A. Note that, the learning apparatus 10 may be configured by a plurality of physically and/or logically separated apparatuses. In this case, each of the plurality of apparatuses can include the hardware configuration described above.

The bus 5A is a data transmission path for the processor 1A, the memory 2A, the peripheral circuit 4A, and the input/output interface 3A to mutually transmit and receive data. The processor 1A is, for example, an arithmetic processing apparatus such as a CPU or a graphics processing unit (GPU). The memory 2A is, for example, a memory such as a random access memory (RAM) or a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, or the like. The processor 1A can give an instruction to each of modules, and perform an arithmetic operation, based on an arithmetic result of each of the modules.

### Advantageous Effect

An estimation model learned by the learning apparatus 10 according to the present example embodiment includes a feature of outputting a plurality of pieces of data “a likelihood of a human body position”, “a correction amount of a human body position”, “depth information of a human body”, “a relative position of each key point”, and “relative depth information of each key point”.

Then, by using a plurality of pieces of data output from the estimation model, “position information, in a real space, of a human body (a position coordinate, on an image, of a human body, and order, in the depth direction in a real space, of a human body)” and “position information, in a real space, of a key point associated with the human body (a position coordinate, on an image, of a key point associated with a human body, and a relative position, in the depth direction, of a key point associated with a human body with a human body center as a criterion)”, being information similar to position information, in a real space, at a key point of a human body can be derived.

Further, the plurality of pieces of data output from the estimation model can be easily collected/generated manually with only a human body image. Thus, a sufficient amount and variation of learning data can be easily collected/generated. The learning apparatus 10 as above can easily learn/construct an estimation model learned with a sufficient amount and variation of learning data in an apparatus that estimates, by use of a learned estimation model, position information, in a real space, at a key point of a human body from an image.

Moreover, the learning apparatus 10 according to the present example embodiment can estimate, from a processing image, by use of a learned estimation model, position information, in a real space, of a human body, and position information, in a real space, of a key point associated with the human body, and easily collect/generate learning data of the estimation model without a special apparatus but with only an image. Moreover, even though a plurality of persons are captured inside an image, each key point (each joint point) being three-dimensional skeletal information can be estimated while being associated with each person.

### Fourth Example Embodiment

An estimation apparatus 20 according to the present example embodiment estimates, by use of an estimation model learned by a learning apparatus 10 according to the third example embodiment, position information, in a real space, of a human body (a position coordinate, on an image, of a human body, and order, in a depth direction in a real space, of the human body), and position information, in a real space, of a key point associated with a human body (a position coordinate, on the image, of a key point associated with a human body, and a relative position, in the depth direction, of a key point associated with a human body with a human body center as a criterion). This is described in detail below.

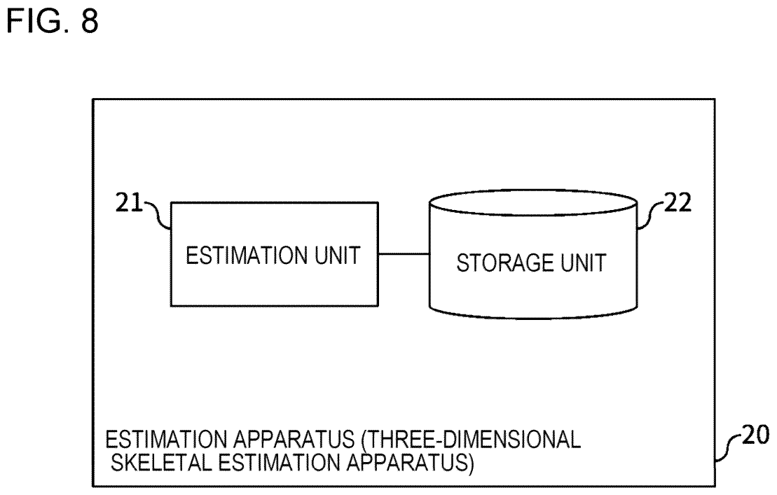

FIG. 8 illustrates one example of a functional block diagram of the estimation apparatus 20. As illustrated in the figure, the estimation apparatus 20 includes an estimation unit 21 and a storage unit 22. Note that, as illustrated in the functional block diagram of FIG. 9, the estimation apparatus 20 may not include the storage unit 22. In this case, an external apparatus configured to be able to communicate with the estimation apparatus 20 includes the storage unit 22.

The estimation unit 21 acquires any image as a processing image. For example, the estimation unit 21 may acquire, as a processing image, an image captured by a camera, or an image from an accumulated video.

Then, the estimation unit 21 estimates, by use of an estimation model learned by the learning apparatus 10, and outputs position information, in a real space, of a human body (a position coordinate, on the image, of the human body, and order, in the depth direction in a real space, of the human body), and position information, in a real space, of a key point associated with the human body (a position coordinate, on the image, of a key point associated with a human body, and a relative position, in the depth direction, of a key point associated with a human body with a human body center as a criterion).

As described in the third example embodiment, once an image is input, an estimation model outputs data described by use of FIGS. 1 to 3, 15, and 16. The estimation unit 21 further performs estimation processing by use of the data output by this estimation model, thereby estimates position information, in a real space, of a human body (a position coordinate, on an image, of the human body, and order, in the depth direction in a real space, of the human body), and position information, in a real space, of a key point associated with the human body (a position coordinate, on the image, of a key point associated with the human body, and a relative position, in the depth direction, of a key point associated with a human body with a human body center as a criterion), and outputs an estimation result. A learned estimation model is stored in the storage unit 22. Output of the estimation result is achieved by utilizing any means such as a display, a projection apparatus, a printer, or email. Moreover, the estimation unit 21 may output data output by the estimation model, as it is as an estimation result.

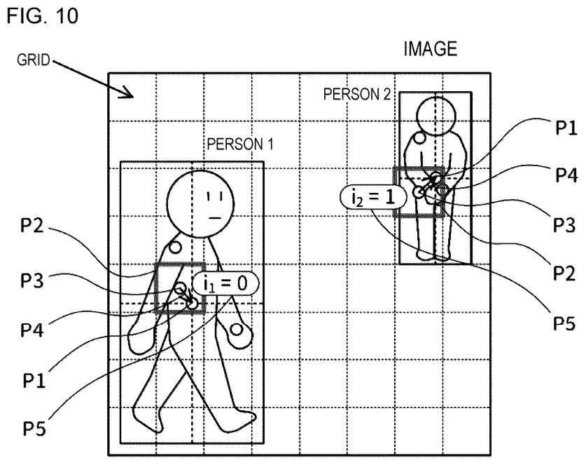

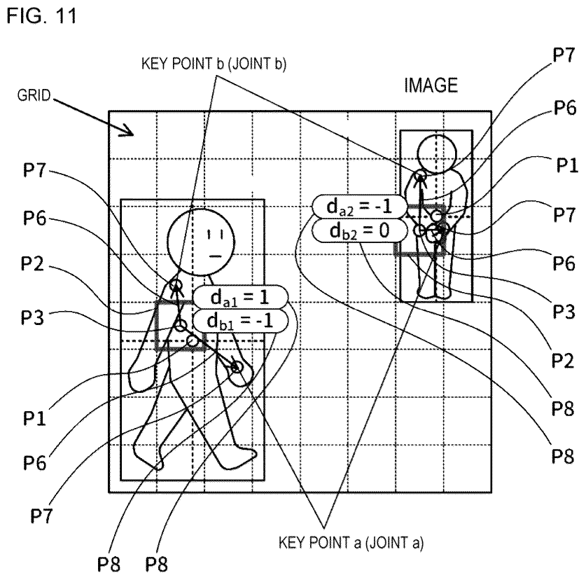

One example of processing performed by the estimation unit 21 is described below by use of FIGS. 10 and 11.

(Step 1): A processing image is processed with an estimation model, and a plurality of pieces of data as illustrated in FIGS. 1 to 3, 15, and 16 are acquired.

(Step 2): Based on data “a likelihood of a human body position”, a grid (P2 in FIG. 10) where a central position (P1 in FIG. 10), on an image, of each person (each human body) is located (included) is determined. Specifically, a grid whose likelihood is equal to or more than a threshold value is determined. Further, from the determined grid, a central position of the grid is determined (P3 in FIG. 10).

(Step 3): From data “a correction amount of a human body position”, a correction amount (P4 in FIG. 10) being relevant to the position of the grid determined in (Step 2) is acquired.

(Step 4): Based on the central position of the grid determined in (Step 2) and the correction amount acquired in (Step 3), a coordinate (P1 in FIG. 10) of the central position of the person on the image is determined for each person included in the processing image. Thereby, a position coordinate, on the image, of each human body is determined.

(Step 5): From data “depth information of a human body”, depth information being relevant to the position of the grid determined in (Step 2), i.e., order in the depth direction in a real space is acquired. Thereby, order, in the depth direction in a real space, of each human body is determined.

(Step 6): From data “a relative position of each key point”, a relative position (P6 in FIG. 11) being relevant to the position of the grid determined in (Step 2) is acquired.

(Step 7): Based on a central position of the grid determined in (Step 2) and the relative position acquired in (Step 6), a position coordinate (P7 in FIG. 11), on the image, of each key point is determined for each person included in the processing image. Thereby, a position coordinate, on the image, of each key point associated with each human body is determined.

(Step 8): From data “relative depth information of each key point”, relative depth information being relevant to the position of the grid determined in (Step 2), i.e., a relative position (P8 in FIG. 11) in the depth direction with a central position, in a real space, of the human body as a criterion is acquired. Thereby, a relative position, in the depth direction with a human body center as a criterion, of each key point associated with each human body is determined.

(Step 9): The position coordinate, on the image, of each human body determined in (Step 4), the order in the depth direction in a real space of each human body determined in (Step 5), the position coordinate, on the image, of each key point associated with each human body determined in (Step 7), and the relative position, in the depth direction with a human body center as a criterion, of each key point associated with each human body determined in (Step 8) are output.

Thereby, the estimation unit 21 can estimate, from an image by use of an estimation model learned by the learning apparatus 10, and output position information, in a real space, of the human body (a position coordinate, on an image, of a human body, and order, in the depth direction in a real space, of a human body), and position information (a position coordinate, on the image, of a key point associated with the human body, and a relative position, in the depth direction, of a key point associated with a human body with a human body center as a criterion) of a key point associated with the human body in a real space.

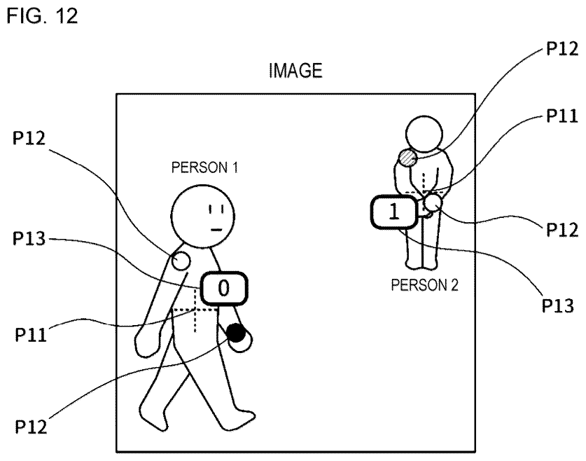

Note that, as illustrated in FIG. 12, the estimation unit 21 is capable of superimposing and displaying estimated information on an image used for estimation. The estimation unit 21 is capable of superimposing and displaying, on a position based on a position coordinate, on an image, of each estimated human body (P11 in FIG. 12) or a position coordinate, on an image, of each key point associated with each estimated human body (P12 in FIG. 12), order, in the depth direction in a real space, of an estimated human body being relevant to the human body (P13 in FIG. 12).

Further, the estimation unit 21 can superimpose and display an object indicating a key point on a position coordinate, on an image, of each key point associated with each estimated human body (P12 in FIG. 12). Then, the estimation unit 21 is capable of setting a color (or a shape, or a size) of the object to a content being relevant to the key point and according to a value of the estimated relative position in the depth direction. As described above, by superimposing and displaying information relating to depth, information relating to depth being difficult to express on an image becomes visually and intuitively easy to understand.

In addition, the display method described above can also be utilized as support in a case of manually generating a correct answer label (learning data) required in order to learn an estimation model. In a case of manually inputting a correct answer label on an image, it is difficult to express the correct answer label in the depth direction on an image, and a mistake in assigning a correct answer occurs. Hence, by utilizing the display method described above, a mistake in assigning a correct answer can be reduced. In a case where a correct level in the depth direction is manually input, sequentially displaying an input state on an image by use of the display method described above, thereby, a state of the correct answer label in the depth direction can be visually understood even on the image, and a mistake in label input is reduced.

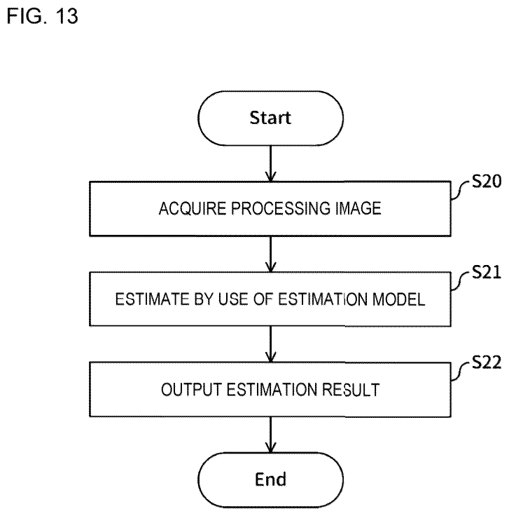

Next, one example of a flow of processing of the estimation apparatus 20 is described by use of a flowchart in FIG. 13.

In S20, the estimation apparatus 20 acquires a processing image. For example, an operator inputs a processing image to the estimation apparatus 20. Then, the estimation apparatus 20 acquires the input processing image.

In S21, by use of an estimation model learned by the learning apparatus 10, the estimation apparatus 20 estimates, from the processing image, position information, in a real space, of the human body (a position coordinate, on an image, of a human body, and order, in the depth direction in a real space, of the human body), and position information, in a real space, of the key point associated with the human body (a position coordinate, on the image, of a key point associated with the human body, and a relative position, in the depth direction, of a key point associated with a human body with a human body center as a criterion). The processing is achieved by the estimation unit 21. Details of the processing executed by the estimation unit 21 are as described above.

In S22, the estimation apparatus 20 outputs an estimation result in S21. The estimation apparatus 20 can utilize any means such as a display, a projection apparatus, a printer, or email.

Next, one example of a hardware configuration of the estimation apparatus 20 is described. Each functional unit of the estimation apparatus 20 is achieved by any combination of hardware and software mainly including a CPU of any computer, a memory, a program loaded onto the memory, a storage unit such as a hard disk that stores the program (that can store not only a program previously stored from a phase of shipping an apparatus but also a program downloaded from a medium such as a CD or a server or the like on the Internet), and an interface for network connection. Then, it is appreciated by a person skilled in the art that there are a variety of modified examples of a method and an apparatus for the achievement. FIG. 17 is a block diagram illustrating a hardware configuration of the estimation apparatus 20.

The estimation apparatus 20 according to the present example embodiment described above can estimate, from a processing image by use of an estimation model learned by the learning apparatus 10 according to the third example embodiment, position information, in a real space, of a human body, and position information, in a real space, of a key point associated with the human body. The estimation apparatus 20 as above is capable of easily collecting/generating learning data of an estimation model without a special apparatus but with only an image, and can easily learn/construct an estimation model. Moreover, the estimation apparatus 20 as above can estimate, even though a plurality of persons are captured inside an image, each key point (each joint point) being three-dimensional skeletal information, while associating the key point with each person.

### Fifth Example Embodiment

Next, a fifth example embodiment is described in detail with reference to the drawings.

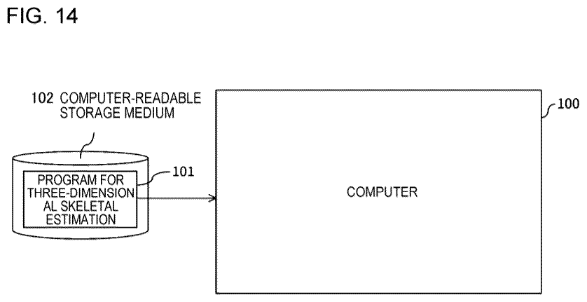

Referring to FIG. 14, in the fifth example embodiment, a computer-readable storage medium 102 storing a program for three-dimensional skeletal estimation 101 is connected to a computer 100.

A computer-readable storage medium 102 is configured by a magnetic disk, a semiconductor memory, or the like, and the program for three-dimensional skeletal estimation 101 stored therein is read by the computer 100 at a time such as startup of the computer 100, controls operation of the computer 100, and thereby causes the computer 100 to function as each of functional units 11, 12, and 13 inside a learning apparatus 10 according to the first and third example embodiments described above, and perform processing illustrated in FIG. 7.

Although the learning apparatus 10 according to each of the first and third example embodiments is achieved by a computer and a program in the present example embodiment, it is also possible to achieve an estimation apparatus 20 according to each of the second and fourth example embodiments by a computer and a program in a similar way.

### Industrial Applicability

The first to fifth example embodiments described above can be adapted to such a purpose as
a three-dimensional skeletal estimation apparatus that can estimate, from an image, position information, in a real space, of a human body and position information, in a real space, of a key point associated with the human body,
a three-dimensional skeletal estimation apparatus that can estimate, even though a plurality of persons are captured inside an image, each key point (each joint point) being three-dimensional skeletal information while associating the key point with each person,
a three-dimensional skeletal estimation apparatus that can easily learn/construct an estimation model in an apparatus that uses a learned estimation model, and estimates position information, in a real space, at a key point of a human body from an image, and
a program for achieving the three-dimensional skeletal estimation apparatuses on a computer.

Moreover, the first to fifth example embodiments described above can be adapted to such a purpose as an apparatus and a function that perform image recognition requiring estimation of position information, in a real space, of a human body and position information, in a real space, of a key point associated with a human body from a camera or an accumulated picture.

Moreover, the first to fifth example embodiments described above can be adapted to such a purpose as an apparatus or a function that performs behavioral analysis in a marketing and surveillance field.

Further, the first to fifth example embodiments described above can be applied to such a purpose as an input interface with, as an input, position information, in a real space of, a human body estimated from a camera or an accumulated picture, and position information, in a real space, of a key point associated with the human body.

In addition, the first to fifth example embodiments described above can be applied to such a purpose as a video/picture search apparatus or function with, as a trigger key, estimated position information, in a real space, of a human body and position information, in a real space, of a key point associated with a human body.

The example embodiments according to the present invention have been described above with reference to the drawings, but are exemplifications of the present invention, and various configurations other than those described above can be adopted. The components according to the example components described above may be combined with one another, or some of the components may be replaced with other components. Moreover, various modifications may be made to the components according to the above-described example embodiments without departing from the scope thereof. Moreover, the components and processing disclosed in each of the above example embodiments and modified examples may be combined with one another.

Moreover, although a plurality of processes (pieces of processing) are described in order in a plurality of flowcharts used in the above description, an execution order of processes executed in each example embodiment is not limited to the described order. In each example embodiment, order of illustrated processes can be changed to an extent that causes no problem in terms of content. Moreover, each of the example embodiments described above can be combined to an extent that content does not contradict.

Note that, in the present specification, “acquisition” includes at least one of “fetching, by a local apparatus, data stored in another apparatus or a storage medium (active acquisition)”, for example, receiving by requesting or inquiring of the another apparatus, accessing the another apparatus or the storage medium and reading, and the like, based on a user input, or based on an instruction of a program, “inputting, into a local apparatus, data output from another apparatus (passive acquisition)”, for example, receiving data given by distribution (or transmission, push notification, or the like), selecting and acquiring from received data or information, based on a user input, or based on an instruction of a program, and “generating new data by editing of data (conversion into text, rearrangement of data, extraction of partial data, changing of a file format, or the like) or the like, and acquiring the new data”.

Some or all of the above-described example embodiments can also be described as, but are not limited to, the following supplementary notes.
1. A learning apparatus including:
   an acquisition unit that acquires learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another; and
   a learning unit that learns, based on the learning data, an estimation model of estimating information indicating a likelihood of a central position, on the image, of each human body, a relative position, on the image, of each key point associated with each human body, and a relative position, in the depth direction, of each key point associated with each human body.
2. The learning apparatus according to supplementary note 1, wherein,
   in the learning data, a correct answer label indicating position information, in the depth direction, of each human body is added and associated, and
   the estimation model is estimated by adding a relative position, on an image, indicating a central position, on the image, of the human body on each human body, and position information, in the depth direction, of each human body.
3. The learning apparatus according to supplementary note 2, wherein
   the position information in the depth direction is order, in the depth direction in a real space, of a person inside an image.
4. The learning apparatus according to any one of supplementary notes 1 to 3, wherein
   the relative position on the image is a relative position on the image with, as a criterion, a center of a grid where a central position, on the image, of a human body is determined to be located, in the information indicating the likelihood, and
   the relative position, in the depth direction, of each key point is a relative position, in the depth direction in a real space, with the central position, in a real space, of the human body as a criterion.
5. The learning apparatus according to supplementary note 4, wherein
   the relative position, in the depth direction, of each key point is set to a negative value in a case where a key point exists on a near side in an image, with a central position, in a real space, of the human body as a criterion, set to a positive value in a case where a key point exists on a far side, or set to 0 in a case where a key point exists at the central position, in a real space, of the human body.
6. The learning apparatus according to supplementary note 4 or 5, wherein
   the learning unit
      estimates, based on the estimation model being learned, information indicating a likelihood of a central position, on an image, on each human body, a relative position, on the image, of each key point associated with each human body, a relative position, in the depth direction, of each key point associated with each human body with the central position, in a real space, of a human body as a criterion, a relative position, on the image, indicating a central position, on the image, of a human body on each human body, and order, in the depth direction, of each human body,
      adjusting a parameter of the estimation model in such a way as to minimize, for all positions of a grid, an error between an estimation result of information indicating a likelihood of a central position, on an image, of each human body and information indicating a likelihood of a central position, on the image, of each human body acquired from the correct answer label,
      adjusting a parameter of the estimation model in such a way as to minimize, for only a position of a grid where a central position, on an image, of the human body is located in learning data, an error between an estimation result of a relative position, on the image, of each key point associated with each human body, and a relative position, on the image, of each key point associated with each human body acquired from the correct answer label,
      adjusting a parameter of the estimation model in such a way as to minimize, for only a position of a grid where a central position, on an image, of a human body is located in learning data, an error between an estimation result of a relative position in the depth direction with, as a criterion, a central position, in a real space, of a human body at each key point associated with each human body, and a relative position in a depth direction with, as a criterion, a central position, in a real space, of a human body at each key point associated with each human body acquired from the correct answer label,
      adjusting a parameter of the estimation model in such a way as to minimize, for only a position of a grid where a central position, on an image, of a human body is located in learning data, an error between an estimation result of a relative position, on an image, indicating a central position, on the image, of the human body on each human body, and a relative position, on the image, indicating a central position, on the image, of a human body on each human body acquired from the correct answer label, and
      adjusting a parameter of the estimation model in such a way as to minimize, for only a position of a grid where a central position, on an image, of a human body is located in learning data, an error between an estimation result of order, in the depth direction, of each human body, and order, in the depth direction, of each human body acquired from the correct answer label.
7. The learning apparatus according to any one of supplementary notes 1 to 6, wherein
   the depth direction is a direction of an optical axis of a camera.
8. An estimation apparatus including:
   an estimation unit that estimates, by use of an estimation model learned by the learning apparatus according to any one of supplementary notes 1 to 7, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.
9. The estimation apparatus according to supplementary note 8, wherein
   the estimation unit
      determines a grid where a central position of each human body on an image is located, based on information indicating a likelihood of a central position, on the image, of each human body acquired from the estimation model,
      acquires, from a relative position, on an image, of each key point associated with each human body acquired from the estimation model, a relative position, on the image, being relevant to the determined position of the grid, and estimates a position coordinate, on the image, of each key point associated with each human body, based on the determined central position of the grid and the acquired relative position on the image,
      acquires a relative position in the depth direction being relevant to the determined position of the grid, from a relative position, in the depth direction, of each key point associated with each human body acquired from the estimation model, with a central position, in a real space, of the human body as a criterion, and estimates a relative position, in the depth direction, of each key point associated with each human body, with a central position, in a real space, of the human body as a criterion,
      acquires a relative position, on an image, being relevant to the determined position of the grid from a relative position, on the image, indicating a central position, on the image, of a human body on each human body acquired from the estimated model, and estimates a position coordinate indicating a central position, on the image, of the human body on each human body, based on the determined central position of the grid and the acquired relative position on the image, and
      acquires order in the depth direction being relevant to the determined position of the grid from the order, in the depth direction, of each human body acquired from the estimation model, and estimates order, in the depth direction, of each human body.
10. The estimation apparatus according to supplementary note 8 or 9, wherein
   the estimation unit superimposes and displays, in an image used for estimation, order of each of the estimated human bodies in the depth direction being relevant to the human body, on a position based on a position coordinate indicating a central position, on the image, of the human body on each of the estimated human bodies, or a position coordinate, on the image, of each key point associated with each of the estimated human bodies.
11. The estimation apparatus according to any one of supplementary notes 8 to 10, wherein
   the estimation unit superimposes and displays, in an image used for estimation, an object indicating a key point on a position coordinate, on the image, of each key point associated with each of the estimated human bodies, and sets a color, a shape, or a size of the object to a content being relevant to the key point and according to a value of a relative position, in the depth direction, of each key point associated with each human body with a central position, in a real space, of the human body as a criterion.
12. The estimation apparatus according to any one of supplementary notes 8 to 11, wherein
   the depth direction is a direction of an optical axis of a camera.
13. A learning method including,
   by one or more computers:
      acquiring learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another; and
      learning, based on the learning data, an estimation model of estimating information indicating a likelihood of a central position, on the image, of each human body, a relative position, on the image, of each key point associated with each human body, and a relative position, in the depth direction, of each key point associated with each human body.
14. A program causing a computer to function as:
   an acquisition unit that acquires learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another; and
   a learning unit that learns, based on the learning data, an estimation model of estimating information indicating a likelihood of a central position, on the image, of each human body, a relative position, on the image, of each key point associated with each human body, and a relative position, in the depth direction, of each key point associated with each human body.
15. An estimation method including,
   by one or more computers,
      estimating, by use of an estimation model learned by the learning apparatus according to any one of supplementary notes 1 to 7, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.
16. A program causing a computer to function as:
   an estimation unit that estimates, by use of an estimation model learned by the learning apparatus according to any one of supplementary notes 1 to 7, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.

This application is based upon and claims the benefit of priority from Japanese patent application No. 2022-200103, filed on Dec. 15, 2022, the disclosure of which is incorporated herein in its entirety by reference.

### REFERENCE SIGNS LIST

10 Learning apparatus
11 Acquisition unit
12 Learning unit
13 Storage unit
20 Estimation apparatus
21 Estimation unit
22 Storage unit
100 Computer
101 Program for three-dimensional skeletal estimation
102 Computer-readable storage medium
1A Processor
2A Memory
3A Input/output I/F
4A Peripheral circuit
5A Bus

What is claimed is:

1. A learning apparatus comprising:
at least one memory configured to store one or more instructions; and
at least one processor configured to execute the one or more instructions to:
acquire learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another; and
learn, based on the learning data, an estimation model of estimating information indicating a likelihood of a central position, on the image, of each human body, a relative position, on the image, of each key point associated with each human body, and a relative position, in the depth direction, of each key point associated with each human body.

2. The learning apparatus according to claim 1, wherein,
in the learning data, a correct answer label indicating position information, in the depth direction, of each human body is added and associated, and
the estimation model is estimated by adding a relative position, on an image, indicating a central position, on the image, of the human body on each human body, and position information, in the depth direction, of each human body.

3. The learning apparatus according to claim 2, wherein
the position information in the depth direction is order, in the depth direction in a real space, of a person inside an image.

4. The learning apparatus according to claim 1, wherein
the relative position on the image is a relative position on the image with, as a criterion, a center of a grid where a central position, on the image, of a human body is determined to be located, in the information indicating the likelihood, and
the relative position, in the depth direction, of each key point is a relative position, in the depth direction in a real space, with the central position, in a real space, of the human body as a criterion.

5. The learning apparatus according to claim 4, wherein
the relative position, in the depth direction, of each key point is set to a negative value in a case where a key point exists on a near side in an image, with a central position, in a real space, of the human body as a criterion, set to a positive value in a case where a key point exists on a far side, or set to 0 in a case where a key point exists at the central position, in a real space, of the human body.

6. The learning apparatus according to claim 4, wherein
wherein the at least one processor is further configured to execute the one or more instructions to
estimate, based on the estimation model being learned, information indicating a likelihood of a central position, on an image, on each human body, a relative position, on the image, of each key point associated with each human body, a relative position, in the depth direction, of each key point associated with each human body with the central position, in a real space, of a human body as a criterion, a relative position, on the image, indicating a central position, on the image, of a human body on each human body, and order, in the depth direction, of each human body,
adjust a parameter of the estimation model in such a way as to minimize, for all positions of a grid, an error between an estimation result of information indicating a likelihood of a central position, on an image, of each human body and information indicating a likelihood of a central position, on the image, of each human body acquired from the correct answer label,
adjust a parameter of the estimation model in such a way as to minimize, for only a position of a grid where a central position, on an image, of the human body is located in learning data, an error between an estimation result of a relative position, on the image, of each key point associated with each human body, and a relative position, on the image, of each key point associated with each human body acquired from the correct answer label,
adjust a parameter of the estimation model in such a way as to minimize, for only a position of a grid where a central position, on an image, of a human body is located in learning data, an error between an estimation result of a relative position in the depth direction with, as a criterion, a central position, in a real space, of a human body at each key point associated with each human body, and a relative position in the depth direction with, as a criterion, a central position, in a real space, of a human body at each key point associated with each human body acquired from the correct answer label,
adjust a parameter of the estimation model in such a way as to minimize, for only a position of a grid where a central position, on an image, of a human body is located in learning data, an error between an estimation result of a relative position, on an image, indicating a central position, on the image, of the human body on each human body, and a relative position, on the image, indicating a central position, on the image, of the human body on each human body acquired from the correct answer label, and
adjust a parameter of the estimation model in such a way as to minimize, for only a position of a grid where a central position, on an image, of a human body is located in learning data, an error between an estimation result of order, in the depth direction, of each human body, and order, in the depth direction, of each human body acquired from the correct answer label.

7. The learning apparatus according to claim 1, wherein
the depth direction is a direction of an optical axis of a camera.

8. An estimation apparatus comprising
at least one memory configured to store one or more instructions; and
at least one processor configured to execute the one or more instructions to:
an estimate, by use of an estimation model learned by the learning apparatus according to claim 1, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.

9. The estimation apparatus according to claim 8, wherein
wherein the at least one processor is further configured to execute the one or more instructions to
determine a grid where a central position of each human body on an image is located, based on information indicating a likelihood of a central position, on the image, of each human body acquired from the estimation model,
acquire, from a relative position, on an image, of each key point associated with each human body acquired from the estimation model, a relative position, on the image, being relevant to the determined position of the grid, and estimate a position coordinate, on the image, of each key point associated with each human body, based on the determined central position of the grid and the acquired relative position on the image,
acquire a relative position in the depth direction being relevant to the determined position of the grid, from a relative position, in the depth direction, of each key point associated with each human body acquired from the estimation model, with a central position, in a real space, of the human body as a criterion, and estimate a relative position, in the depth direction, of each key point associated with each human body, with a central position, in a real space, of the human body as a criterion,
acquire a relative position, on an image, being relevant to the determined position of the grid from a relative position, on the image, indicating a central position, on the image, of a human body on each human body acquired from the estimated model, and estimate a position coordinate indicating a central position, on the image, of the human body on each human body, based on the determined central position of the grid and the acquired relative position on the image, and
acquire order in the depth direction being relevant to the determined position of the grid from the order, in the depth direction, of each human body acquired from the estimation model, and estimate order, in the depth direction, of each human body.

10. The estimation apparatus according to claim 8, wherein the at least one processor is further configured to execute the one or more instructions to
the superimpose and display, in an image used for estimation, order of each of the estimated human bodies in the depth direction being relevant to the human body, on a position based on a position coordinate indicating a central position, on the image, of the human body on each of the estimated human bodies, or a position coordinate, on the image, of each key point associated with each of the estimated human bodies.

11. The estimation apparatus according to claim 8, wherein the at least one processor is further configured to execute the one or more instructions to
superimpose and display, in an image used for estimation, an object indicating a key point on a position coordinate, on the image, of each key point associated with each of the estimated human bodies, and set a color, a shape, or a size of the object to a content being relevant to the key point and according to a value of a relative position, in the depth direction, of each key point associated with each human body with a central position, in a real space, of the human body as a criterion.

12. The estimation apparatus according to claim 8, wherein
the depth direction is a direction of an optical axis of a camera.

13. A learning method comprising,
by one or more computers:
acquiring learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another; and
learning, based on the learning data, an estimation model of estimating information indicating a likelihood of a central position, on the image, of each human body, a relative position, on the image, of each key point associated with each human body, and a relative position, in the depth direction, of each key point associated with each human body.

14. The learning method according to claim 13, further comprising,
in the learning data, adding and associating a correct answer label indicating position information, in the depth direction, of each human body, wherein
the estimation model is estimated by adding a relative position, on an image, indicating a central position, on the image, of the human body on each human body, and position information, in the depth direction, of each human body.

15. A non-transitory computer-readable medium storing a program causing a computer to:
acquire learning data in which a training image including a human body, a correct answer label indicating a central position, on the image, of each human body, a correct answer label indicating a position, on the image, of each key point on each human body, and a correct answer label indicating a relative position, in a depth direction, of each key point on each human body are associated with one another; and
learn, based on the learning data, an estimation model of estimating information indicating a likelihood of a central position, on the image, of each human body, a relative position, on the image, of each key point associated with each human body, and a relative position, in the depth direction, of each key point associated with each human body.

16. The non-transitory computer-readable medium according to claim 15, wherein,
in the learning data, a correct answer label indicating position information, in the depth direction, of each human body is added and associated, and
the estimation model is estimated by adding a relative position, on an image, indicating a central position, on the image, of the human body on each human body, and position information, in the depth direction, of each human body.

17. An estimation method comprising,
by one or more computers,
estimating, by use of an estimation model learned by the learning apparatus according to claim 1, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.

18. The estimation method according to claim 17, further comprising,
by the one or more computers:
determining a grid where a central position of each human body on an image is located, based on information indicating a likelihood of a central position, on the image, of each human body acquired from the estimation model;
acquiring, from a relative position, on an image, of each key point associated with each human body acquired from the estimation model, a relative position, on the image, being relevant to the determined position of the grid, and estimating a position coordinate, on the image, of each key point associated with each human body, based on the determined central position of the grid and the acquired relative position on the image;
acquiring a relative position in the depth direction being relevant to the determined position of the grid, from a relative position, in the depth direction, of each key point associated with each human body acquired from the estimation model, with a central position, in a real space, of the human body as a criterion, and estimating a relative position, in the depth direction, of each key point associated with each human body, with a central position, in a real space, of the human body as a criterion;
acquiring a relative position, on an image, being relevant to the determined position of the grid from a relative position, on the image, indicating a central position, on the image, of a human body on each human body acquired from the estimated model, and estimating a position coordinate indicating a central position, on the image, of human body on each human body, based on the determined central position of the grid and the acquired relative position on the image; and
acquiring order in the depth direction being relevant to the determined position of the grid from the order, in the depth direction, of each human body acquired from the estimation model, and estimating order, in the depth direction, of each human body.

19. A non-transitory computer-readable medium storing a program causing a computer to:
estimate, by use of an estimation model learned by the learning apparatus according to claim 1, a position coordinate, on an image, of each key point associated with each human body, a relative position, in a depth direction, of each key point associated with each human body with a central position, in a real space, of the human body as a criterion, a position coordinate indicating a central position, on the image, of a human body on each human body, and order, in the depth direction, of each human body.

20. The non-transitory computer-readable medium according to claim 19, wherein
the program causing the computer to
determine a grid where a central position of each human body on an image is located, based on information indicating a likelihood of a central position, on the image, of each human body acquired from the estimation model,
acquire, from a relative position, on an image, of each key point associated with each human body acquired from the estimation model, a relative position, on the image, being relevant to the determined position of the grid, and estimate a position coordinate, on the image, of each key point associated with each human body, based on the determined central position of the grid and the acquired relative position on the image,
acquire a relative position in the depth direction being relevant to the determined position of the grid, from a relative position, in the depth direction, of each key point associated with each human body acquired from the estimation model, with a central position, in a real space, of the human body as a criterion, and estimate a relative position, in the depth direction, of each key point associated with each human body, with a central position, in a real space, of the human body as a criterion,
acquire a relative position, on an image, being relevant to the determined position of the grid from a relative position, on the image, indicating a central position, on the image, of a human body on each human body acquired from the estimated model, and estimate a position coordinate indicating a central position, on the image, of human body on each human body, based on the determined central position of the grid and the acquired relative position on the image, and
acquire order in the depth direction being relevant to the determined position of the grid from the order, in the depth direction, of each human body acquired from the estimation model, and estimate order, in the depth direction, of each human body.
